(19) United States
(12) Patent Application Publication
(10) Pub. No.: US 2007/0205591 A1
(43) Pub. Date: Sep. 6, 2007

(54) Airbag apparatus for a front passenger's seat

(75) Inventor: Kazuaki Bito, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/711,701

(22) Filed: Feb. 28, 2007

(30) Foreign Application Priority Data
Mar. 3, 2006 (JP) 2006-057909

(51) Int. Cl. B60R 21/205; B60R 21/23

(52) U.S. Cl. 280/743.2; 280/732; 280/728.2

(57) ABSTRACT

The airbag apparatus for a front passenger's seat includes an airbag provided on its rear side with a protection portion contactable with a passenger. The airbag internally includes a vertical tether for controlling the contour of the airbag upon inflation depending on a passenger. The protection portion includes each one left and right shoulder restraining portion disposed side by side along the lateral direction for contact with left and right shoulders of the passenger. The vertical tether works to vary a distance between the shoulder restraining portions in the lateral direction at the complete airbag inflation into a wide distance correspondent to a large passenger and a narrow distance correspondent to an undersized passenger.

The present application claims priority from Japanese Patent Application No. 2006-057909 of Bito, filed on Mar. 3, 2006, the disclosure of which is hereby incorporated into the present application by reference.

### BACKGROUND OF THE INVENTION

1. Field of the Invention

The present invention relates to an airbag apparatus for a front passenger's seat including an airbag which is folded and housed in the instrument panel in front of the front passenger's seat and is deployable rearward when fed with inflation gas.

2. Description of Related Art

In a conventional airbag apparatus for a front passenger's seat, an airbag includes a gas inlet port for introducing an inflation gas in the vicinity of its front end, and a passenger protection area in its rear region for receiving a passenger seated in the front passenger's seat. Further, the airbag internally includes means for controlling the contour of the airbag at complete inflation according to the physical size of the passenger.

Such an airbag apparatus is shown by way of example in JP 2003-515483. An airbag of this apparatus includes a gas inlet port, a rear side wall disposed in the rear region, and a tether that regulates a clearance between the vicinity of the inlet port and rear side wall upon airbag inflation. The clearance is controllable by changing the length of the tether depending on a passenger.

Another airbag apparatus for a front passenger's seat is shown in JP 2005-162195. An airbag of the apparatus includes, when inflated, a recessed portion in the vicinity of the lateral center of its rear region, and regions projecting rearward at left and right sides of the recessed portion. The airbag is adapted to protect shoulders of a passenger by the projecting regions.

In this kind of airbag apparatus, the airbag desirably restrains the shoulders of a passenger so as to reduce the kinetic energy of the moving passenger when the fully inflated airbag contacts with the passenger. However, the position of the passenger's shoulders is variable according to the physical size of the seated passenger.

### SUMMARY OF THE INVENTION

An object of the present invention is to provide an airbag apparatus for a front passenger's seat capable of protecting a seated passenger properly depending on the physical size of the passenger.

The object of the present invention is attained by an airbag apparatus as follows: The airbag apparatus for a front passenger's seat includes an airbag folded and housed inside an instrument panel in front of the front passenger's seat, and being deployable rearward when fed with inflation gas, and a regulating member for controlling the contour of the airbag at complete inflation depending upon the passenger. The airbag, when completely inflated, is formed into a contour having a left side wall and a right side wall deployed at lateral sides of the airbag, an upper side wall and a lower side wall deployed in upper and lower sides of the airbag, and a rear side wall arranged generally vertically to face toward the front passenger's seat. The airbag further includes a gas inlet port for introducing inflation gas and a protection portion contactable with a passenger seated in the front passenger's seat, in a rear side of the airbag as completely inflated. The protection portion includes each one left and right shoulder restraining portion disposed side by side along the lateral direction and contactable with left and right shoulders of the passenger upon airbag inflation. The regulating member is used to vary a distance between the shoulder restraining portions in the lateral direction at the complete inflation of airbag depending upon the passenger, to a wide distance correspondent to a large passenger and to a narrow distance correspondent to an undersized passenger.

The airbag apparatus according to the present invention includes the regulating member that is capable of varying the lateral distance between left and right shoulder restraining portions of airbag expected to contact with shoulders of the passenger at complete airbag inflation. If an undersized or small-build passenger is seated in the front passenger's seat, the regulating member works to set the lateral distance between the left and right shoulder restraining portions for the narrow distance upon airbag inflation. On the contrary, if a large-build passenger is seated, the regulating member works to set the lateral distance for the wide distance upon airbag inflation. Consequently, if the size of passenger can vary, the airbag securely restrains shoulders of the passenger by left and right shoulder restraining portions, thereby protecting the passenger properly.

Therefore, the airbag apparatus for a front passenger's seat of the present invention properly protects a passenger depending on the physical size of the passenger.

In the airbag apparatus for a front passenger's seat of the present invention, it is desired that the regulating member includes a vertical tether arranged along the longitudinal direction, one of opposite ends of the vertical tether being connected to a region of the protection portion between the left and right shoulder restraining portions, such that, when the vertical tether is pulled forward to make a space between the shoulder restraining portions recessed whereas the shoulder restraining portions projected, the distance between the shoulder restraining portions in the lateral direction is set for the narrow distance.

With this arrangement, if the lateral distance between the left and right shoulder restraining portions is set for the narrow distance corresponding to an undersized passenger, the airbag completes inflation in a state where the shoulder restraining portions are projected whereas a space between the restraining portions is recessed. When this airbag is thrown against an undersized passenger, the left and right shoulder restraining portions firstly bump against the vicinities of left and right shoulders of the passenger, thereby reducing forward kinetic energy of the passenger. Thereafter, the head of the undersized passenger whose shoulders are restrained by the restraining portions enters into the recessed space provided between the restraining portions, and then is restrained and suppressed from moving forward. Accordingly, the airbag is capable of receiving the head of the undersized passenger softly while applying less reaction force.

If the regulating member of the above airbag apparatus includes the vertical tether, it is desired that: the airbag is formed by joining edges of predetermined-shaped base cloths; the airbag includes an outer panel constituting the left side wall and the right side wall and an inner panel constituting the upper side wall, the lower side wall and the rear side wall; the inner panel has a generally band shape wherein the upper sidewall, the rear side wall and the lower side wall are arranged in series, opposite edges in a width direction of the inner panel are curved such that a central region in a length direction of the inner panel has a wider width; the inner panel includes a central joint portion extending along the length direction in the vicinity of a center in the width direction of the inner panel, the central joint portion being formed by overlapping and joining a part of the inner panel; opposite edges of the central joint portion before being joined are curved to project toward opposite sides in a width direction of the central joint portion at a central region in a length direction of the central joint portion when the inner panel is flattened and developed; marginal joint portions, which is formed by joining outer edges of regions of the outer panel to form the left and right side walls and opposite edges of the inner panel in the width direction, constitute projected tops of the left and right shoulder restraining portions of the protection portion; the central joint portion constitutes a recess arranged continuously from an upper side to rear side of the airbag between the left and right shoulder restraining portions; and the vertical tether is connected to the central joint portion of the inner panel at the one of opposite ends of the vertical tether.

With this structure, the central joint portion is arranged along the vertical direction in the vicinity of the lateral center of the rear side wall of the fully inflated airbag. The vertical tether is connected to this central joint portion. Since the central joint portion forms the recess extending continuously from upper side to rear side of the airbag between the shoulder restraining portions, if the regulating member is actuated to pull the tether so a distance from the rear side wall to the gas inlet port of the airbag is reduced, the whole inner panel is drawn in toward the gas inlet port, so that the projected tops of the shoulder restraining portions formed by joining the opposite edges of the inner panel and the outer edges of the regions of the outer panel to form the left and right side walls move to reduce the distance therebetween. Accordingly, the distance between the left and right shoulder restraining portions is smoothly reduced merely by shortening the length of the vertical tether, which is preferable.

The marginal joint portions defining the projected tops of the left and right shoulder restraining portions are formed by joining the outer edges of the regions of the outer panel to form the left and right side walls respectively with the opposite edges of the inner panel in the width direction. These outer edges and edges are so curved to protrude outward in each of the panels, and therefore, define the largest circumference of the airbag in the longitudinal direction. In view of this, if the vertical tether pulls the central joint portion to draw in the whole inner panel toward the gas inlet port upon airbag deployment, the edge portions easily form the most projected portions. Therefore, if the airbag completes inflation with the lateral distance between the shoulder restraining portions set for the narrow distance, the left and right shoulder restraining portions securely restrain left and right shoulders of an undersized passenger with their most projected portions.

Moreover, if at least a rear end region of the vertical tether has a band shape extending generally vertically, and the vertical tether is joined to the central joint portion in a state where a rear end of the rear end region is arranged along the central joint portion, the joint strength of the vertical tether to the central joint portion is stabilized. In addition, in the above airbag apparatus, the joint of the vertical tether to the central joint portion constitutes the most recessed region of the recess formed between the shoulder restraining portions when the airbag inflates with the narrow distance corresponding to the undersized passenger. Accordingly, if the joint arranged along the central joint portion has a certain amount of width, the recessed shape of the recess will be stabilized, which is preferable.

Furthermore, it is desired that the joint of the vertical tether to the central joint portion is located at a position to confront a head of the undersized passenger when the airbag completes inflation with the vertical tether pulled forward. With this structure, the recess will receive the head of the undersized passenger with the most recessed portion, and the head will be protected softly.

It will also be appreciated that the regulating member includes a laterally tethered portion arranged along the lateral direction to connect the left side wall and right side wall, such that the lateral distance between the shoulder restraining portions at the complete inflation of airbag is set for the narrow distance when the laterally tethered portion is pulled.

### BRIEF DESCRIPTIONS OF DRAWINGS

FIG. 1 illustrates an airbag apparatus for a front passenger's seat embodying the present invention, an instrument panel equipped with the airbag apparatus and a passenger from side of vehicle;

FIG. 2 is a sectional view of the airbag apparatus embodying the present invention;

FIG. 3 is a schematic section of an anchor mechanism used in the airbag apparatus of FIG. 2;

FIG. 4 is a perspective view of an airbag used in the airbag apparatus of FIG. 2, inflated by itself and viewed from the rear;

FIG. 5 is a perspective view of the airbag of FIG. 4, inflated by itself and viewed from the front;

FIG. 6A is a sectional view of the airbag of FIG. 4 inflated by itself with a lateral distance between shoulder restraining portions set for a wide distance, taken along line VI-VI of FIG. 5;

FIG. 6B is a sectional view of the airbag of FIG. 4 inflated by itself with the lateral distance between the shoulder restraining portions set for a narrow distance, taken along line VI-VI of FIG. 5;

FIG. 7A is a cross section of the airbag of FIG. 4 inflated by itself with the lateral distance between the shoulder restraining portions set for the wide distance, taken along line VII-VII of FIG. 6A;

FIG. 7B is a cross section of the airbag of FIG. 4 inflated by itself with the lateral distance between the shoulder restraining portions set for the narrow distance, taken along line VII-VII of FIG. 6A;

FIG. 8 illustrates components of the airbag of FIG. 4 by plan views;

FIG. 9A illustrates the airbag apparatus of FIG. 2 in service from the rear, wherein the airbag is inflated with the lateral distance between the shoulder restraining portions set for the wide distance;

FIG. 9B illustrates the airbag apparatus of FIG. 2 in service from the rear, wherein the airbag is inflated with the lateral distance between the shoulder restraining portions set for the narrow distance;

FIG. 10A schematically illustrates the airbag apparatus of FIG. 2 in service from the side, wherein the airbag is inflated with the lateral distance between the shoulder restraining portions set for the wide distance;

FIG. 10B schematically illustrates the airbag apparatus of FIG. 2 in service from the side, wherein the airbag is inflated with the lateral distance between the shoulder restraining portions set for the narrow distance;

FIG. 11 schematically illustrates the airbag apparatus of FIG. 2 in service from above, wherein the airbag is inflated with the lateral distance between the shoulder restraining portions set for the wide distance;

FIG. 12 schematically illustrates the airbag apparatus of FIG. 2 in service from above, wherein the airbag is inflated with the lateral distance between the shoulder restraining portions set for the narrow distance;

FIG. 13 is a schematic section of an airbag apparatus for a front passenger's seat according to an alternative embodiment of the present invention, as viewed from above and wherein an airbag is inflated;

FIG. 14 is a schematic section of an airbag apparatus according to a further alternative embodiment, as viewed from above and wherein an airbag is inflated;

FIG. 15A is a schematic section of an airbag according to yet another embodiment, inflated with the lateral distance between the shoulder restraining portions set for the wide distance;

FIG. 15B is a schematic section of the airbag of FIG. 15A, inflated with the lateral distance between the shoulder restraining portions set for the narrow distance; and

FIG. 16 is a schematic view of an airbag apparatus according to still another embodiment, as viewed from above and wherein an airbag is inflated.

### DESCRIPTION OF PREFERRED EMBODIMENTS

Preferred embodiments of the present invention are now described below with reference to the accompanying drawings. However, the invention is not limited to the embodiments disclosed herein. All modifications within the appended claims and equivalents relative thereto are intended to be encompassed in the scope of the claims.

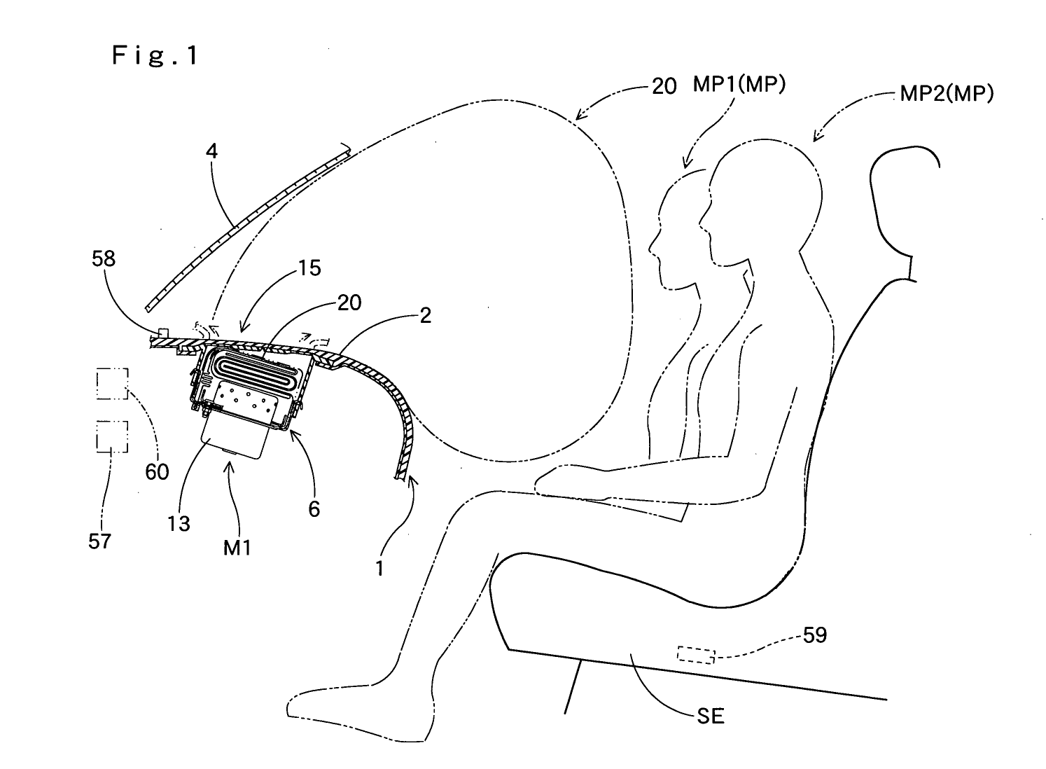

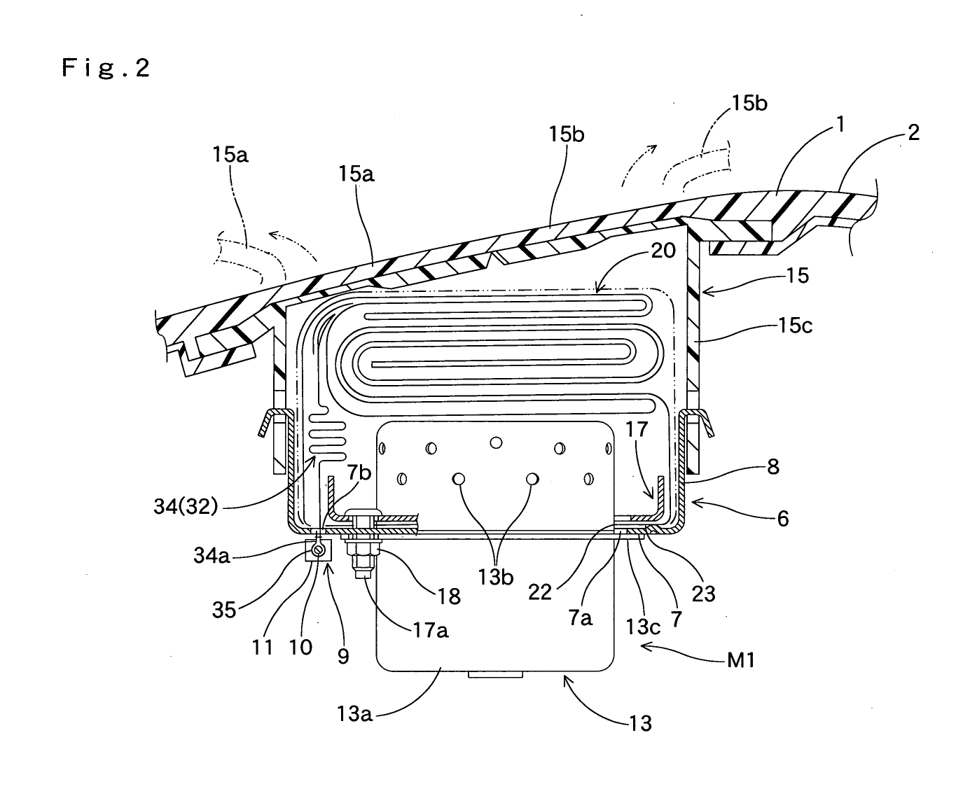

FIG. 1 shows an airbag apparatus M1 embodying the present invention, which is a top-mount type that is disposed in an interior of a top face 2 of an instrument panel or dashboard 1. As shown in FIGS. 1 and 2, the airbag apparatus M1 includes a folded airbag 20, an inflator 13 for supplying the airbag 20 with inflation gas, a case 6 for housing and holding airbag 20 and inflator 13, a retainer 17 for attaching airbag 20 to case 6, an airbag cover 15 for covering the folded airbag 20, a vertical tether 32 disposed inside airbag 20 to serve as a regulating member, and an anchor mechanism 9 serving as a pulling mechanism for pulling vertical tether 32. The activation of inflator 13 and anchor mechanism 9 is controlled by a control device 57.

Up-down, front-rear, and left-right directions in this specification correspond to up-down, front-rear, and left-right directions of a vehicle being steered straight forward.

As shown in FIG. 1, control device 57 is electrically communicated with a position sensor 58, which is a kind of occupant sensor, for detecting the size of a passenger MP seated in a seat SE, a weight sensor 59 which is also a kind of occupant sensor for detecting the weight of passenger MP, and a collision sensor 60 for detecting the acceleration of vehicle and direction of acceleration. In response to electric signals fed from position sensor 58, weight sensor 59, and collision sensor 60, control device 57 activates inflator 8 and anchor mechanism 9.

Airbag cover 15 is integral with dashboard 1 made from synthetic resin, and includes two doors, i.e. front and rear doors 15a and 15b adapted to open when pushed by the inflating airbag 20 upon airbag deployment. Airbag cover 15 further includes a joint wall 15c by which airbag cover 15 is coupled to case 6. Joint wall 15c is arranged around doors 15a and 15b of airbag cover 15.

Inflator 13 includes a body portion 13a having a generally columnar shape and provided with gas discharge ports 13b, and a flange 13c for attaching inflator 13 to case 6.

Case 6 is made of sheet metal into a generally rectangular parallelepiped shape, and has a rectangular opening at the top. Case 6 includes a bottom wall 7 of a generally rectangular plate shape and a circumferential wall 8 extending upward from outer edge of bottom wall 7. Inflator 13 is set in an insert hole 7a of bottom wall 7 from lower side and attached to bottom wall 7. Circumferential wall 8 retains joint wall 15c of airbag cover 15. Case 6 is further provided with unillustrated brackets, in bottom wall 7, for attachment of case 6 to the vehicle body. In the vicinity of insert hole 7a of bottom wall 7 is a through hole 7b which a later-described loop 35 disposed at the leading end 34a of a belt 34 of vertical tether 32 is put through. Anchor mechanism 9 is located in the vicinity of through hole 7b for anchoring the leading end 34a of belt 34 and pulling vertical tether 32 upon deployment of airbag 20.

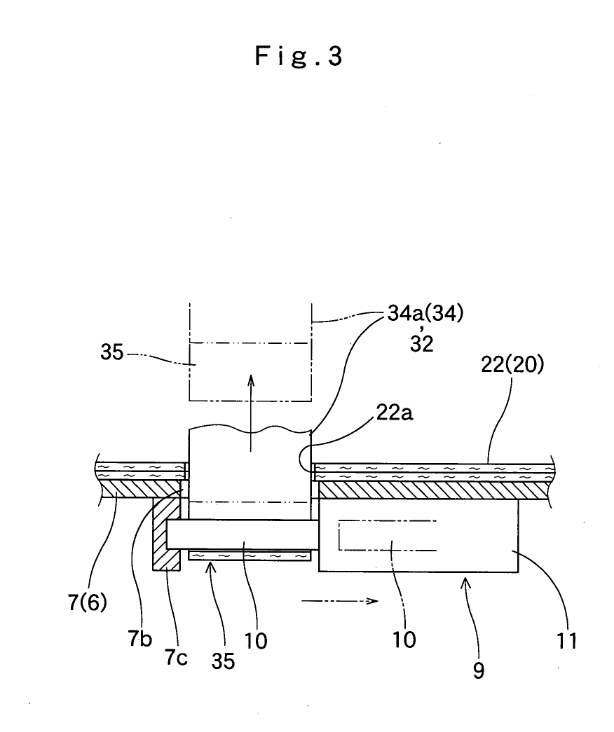

Anchor mechanism 9 includes an anchor pin 10 to be put through loop 35 formed at leading end 34b of belt 34, and an actuator 11 secured to the lower side of bottom wall 7 for retracting pin 10. If actuator 11 retracts pin 10, anchor pin 10 stops retaining loop 35 and moves to are lease mode. Actuator 11 can be a piston cylinder utilizing fluid pressure such as hydraulic pressure, water pressure, air pressure, or gas pressure which is generated by inflation gas discharged from the inflator, a motor utilizing such fluid pressure or electricity, an electromagnetic solenoid, a spring which exerts biasing force when restoring, or the like, provided that it can move anchor pin 10 in response to electric signals fed from control device 57. As shown in FIG. 3, in the opposite periphery of through hole 7c with respect to actuator 11 and on the lower side of bottom wall 7 is a support 7c for supporting the leading end of pin 10 of anchor mechanism 9 and keeping loop 35 anchored or retained by pin 10.

Airbag 20 and inflator 13 are secured to case 6 by attaching an annular retainer 17 inside airbag 20 such that bolts 17a of retainer 17 are put through airbag 20, flange 13c of inflator 13, and bottom wall 7 of case 6, and then fastened into nuts 18.

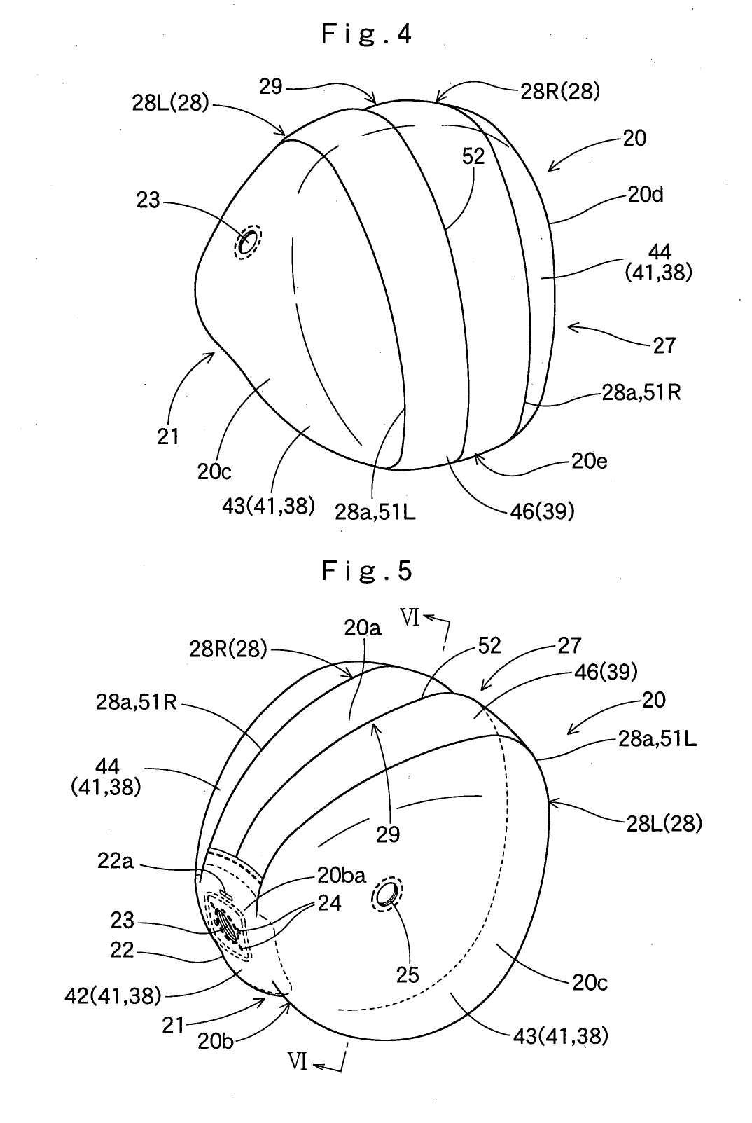

Referring to FIGS. 4 to 7, when fully inflated, airbag 20 is formed into a generally square conical shape whose top is in a front end of airbag 20. Airbag 20 includes an upper side wall 20a and a lower side wall 20b extending generally along the lateral direction in upper and lower sides, a left side wall 20c and a right side wall 20d extended generally along the longitudinal direction in left and right sides, and a rear side wall 20e extended generally along the lateral direction to face a passenger, in such a manner as to connect upper side wall 20a and lower side wall 20b. Airbag 20 of the embodiment includes a protection portion 27 arranged in a rear side to face toward a passenger upon airbag inflation, and a vehicle body side portion 21 arranged forward of protection portion 27 and between dashboard 1 and a wind shield 4 upon airbag inflation. Vehicle body side portion 21 has a generally cylindrical shape closed at its front end. Airbag 20 further includes a round gas inlet port 23 for introducing inflation gas, in the vicinity of the lateral center of vehicle body side portion 21 and proximate to a front end of lower side wall 20b of the fully inflated airbag 20. In a periphery 22 of inlet port 23 are mounting holes 24 for receiving bolts 17a of retainer 17 to attach the peripheral region 22 of port 23 to bottom wall 7 of case 6. In the peripheral region 22 and in a front side of inlet port 23 is the through hole 22a for belt 34 of vertical tether 32 to be put through.

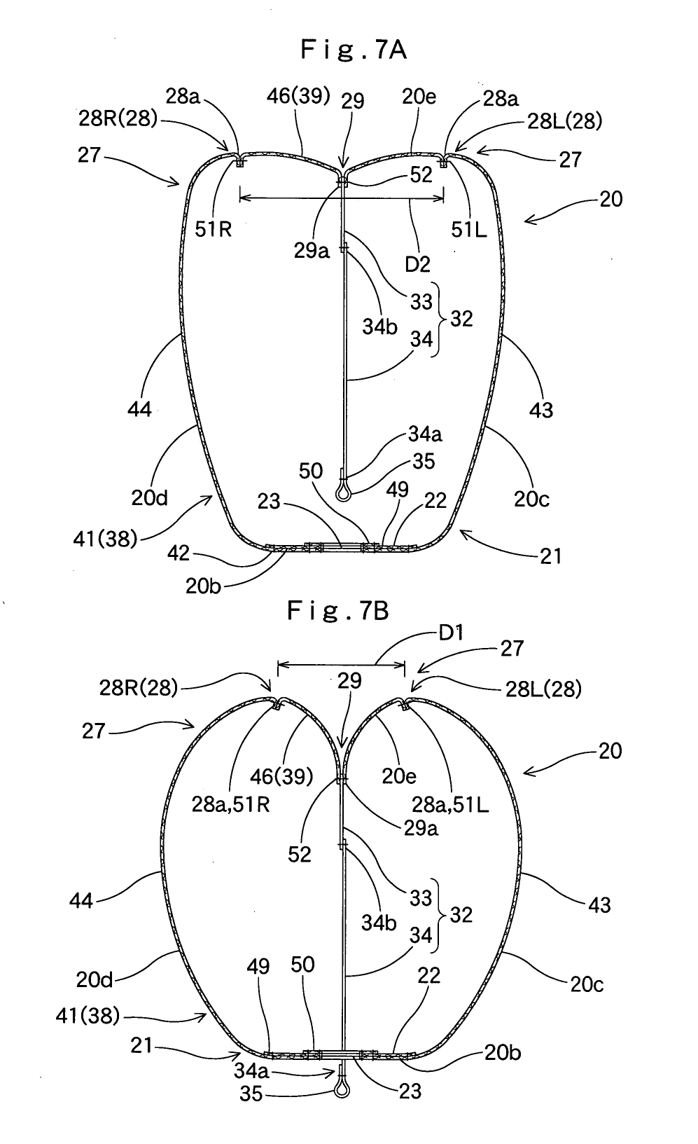

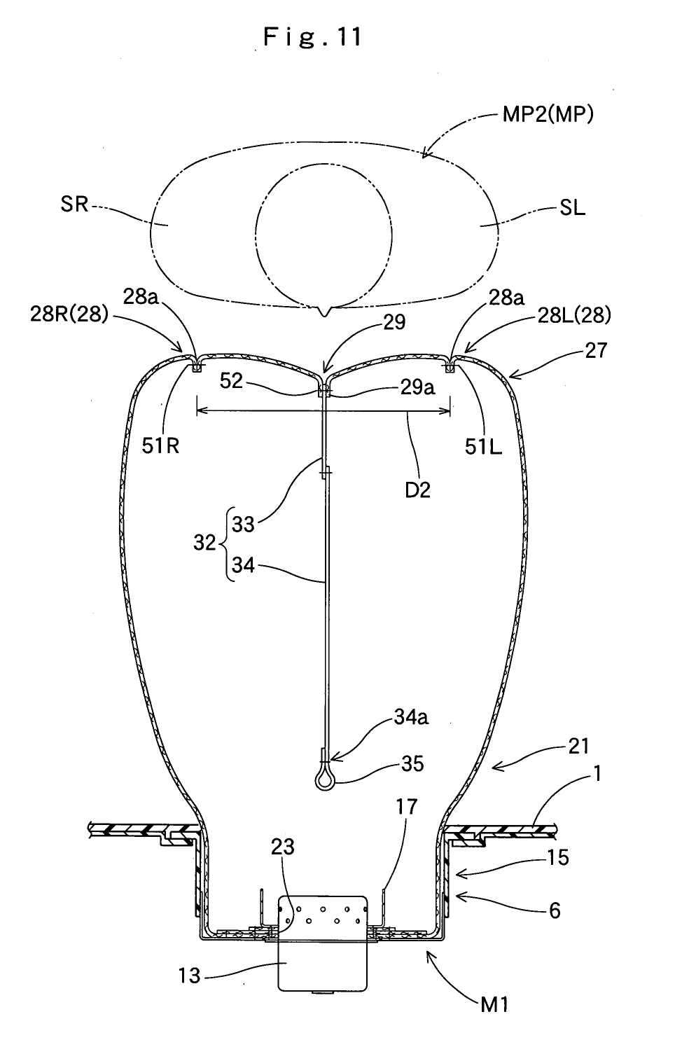

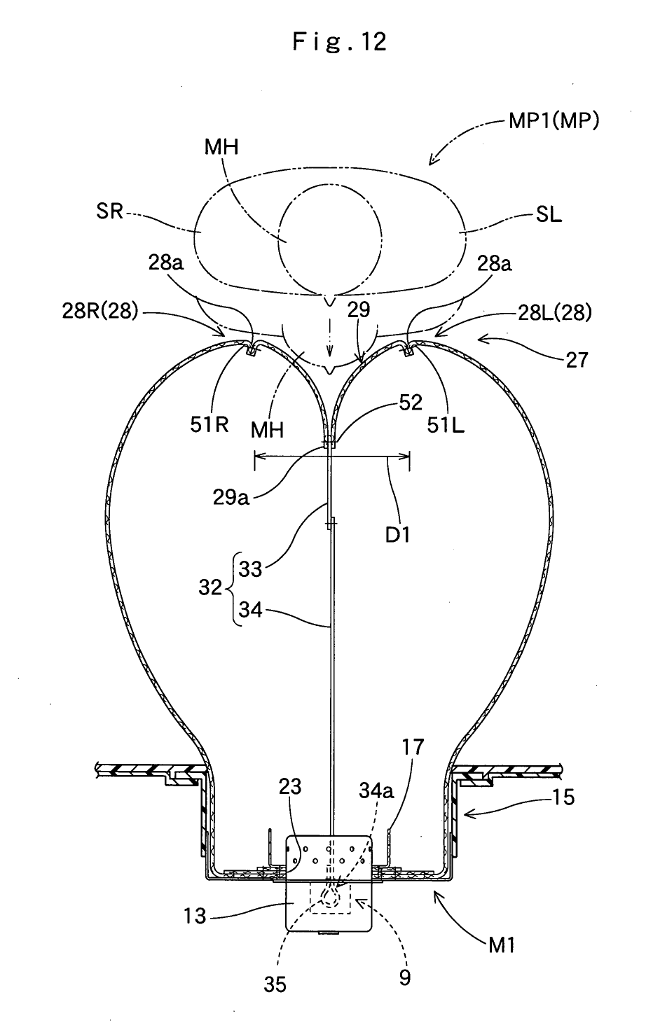

Protection portion 27 includes shoulder restraining portions 28L and 28R each extending vertically and disposed side by side in the lateral direction, and a recess 29 extending from an upper side to a rear side of airbag 20 in a slightly recessing manner between left and right shoulder restraining portions 28L and 28R. As shown in FIGS. 11 and 12, left and right shoulder restraining portions 28L and 28R are adapted to be deployed in positions to contact with left and right shoulders SL and SR of passenger MP, upon airbag inflation. In this embodiment, the distance between left and right shoulder restraining portions 28L and 28R in the lateral direction at complete airbag inflation is variable based upon a seated passenger MP by use of a later-described vertical tether or regulating member 32, i.e. to a narrow distance D1 for an undersized passenger MP1 or to a wide distance D2 for a large passenger MP2 (FIGS. 7A, 7B, 9A, 9B, 11 and 12). When the airbag completes inflation with the distance between left and right restraining portions 28L and 28R set for narrow distance D1, the leading end 29a of recess 29 is pulled toward gas inlet port 23 so that recess 29 is recessed significantly (FIGS. 7B and 12).

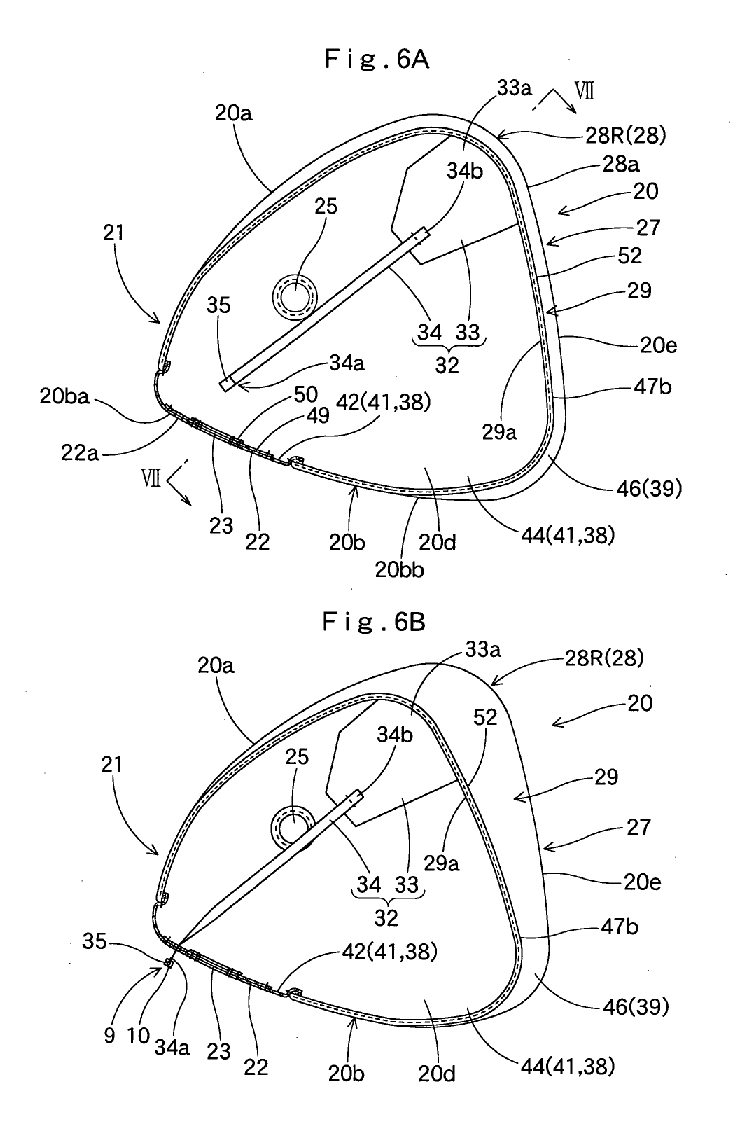

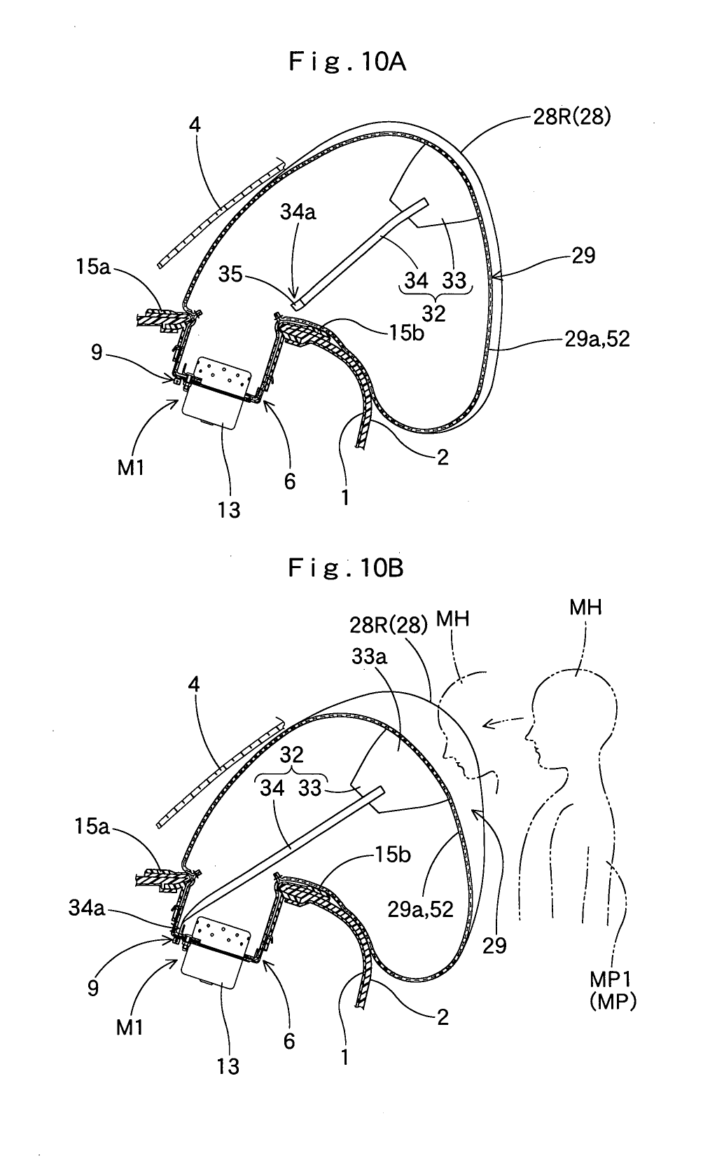

As shown in FIGS. 6A, 6B, 7A and 7B, vertical tether 32 serving as the regulating member is disposed inside airbag 20 generally along the longitudinal direction of vehicle. Tether 32 includes an attachment portion 33 arranged at the rear end and having a trapezoidal band-shape and a belt 34 coupled to attachment portion 33 and arranged at the front end side. Attachment portion 33 is made of flexible woven cloth, and is joined at its broader base side to the vicinity of a later-described sewn portion or central joint portion 52 constituting the leading end region 29a of recess 29 between left and right shoulder restraining portions 28L and 28R. At this time, the broader base side of attachment portion 33 is arranged along the sewn portion 52. In this embodiment, a joint 33a of attachment portion 33 to sewn portion 52 is located at the vicinity of the upper end of airbag 20 at complete inflation in the leading end region 29a of recess 29. Since the joint 33a of attachment portion 33 constitutes the most recessed region of recess 29 when tether 32 is pulled, attachment portion 33 is desirably disposed in a position corresponding to a head MH of undersized passenger MP1. In this embodiment, attachment portion 33 is arranged at a position facing head MH of undersized passenger MP1 upon airbag inflation so that the part of airbag 20 expected to contact head MH of undersized passenger MP1 is recessed significantly when tether 32 is pulled (FIG. 10B).

Belt 34 is made of a flexible, band-shaped cloth member, and is joined to attachment portion 33 at its root region 34b. At the leading end 34a of belt 34 is a loop 35 made by sewing up its end region into a ring shape. Loop 35 is to receive anchor pin 10. As shown in FIGS. 2 and 3, when airbag 20 is in the folded and housed state, loop 35 is put through the through hole 22a formed in the peripheral region 22 of gas inlet port 23 and through hole 7b formed in bottom wall 7 of case 6, and is anchored by anchor mechanism 9 with anchor pin 10 put there through. Belt 34 has such a length as to make the lateral distance between left and right shoulder restraining portions 28L and 28R to be narrow distance D1 adapted to protect undersized passenger MP1 when airbag 20 completes inflation with belt 34 retained by anchor pin 10. On the other hand, airbag 20 of this embodiment is constructed such that the distance in the lateral direction between left and right restraining portions 28L and 28R is wide distance D2 adapted to protect large passenger MP2 when airbag 20 completes inflation with belt 34 released from anchor pin 10.

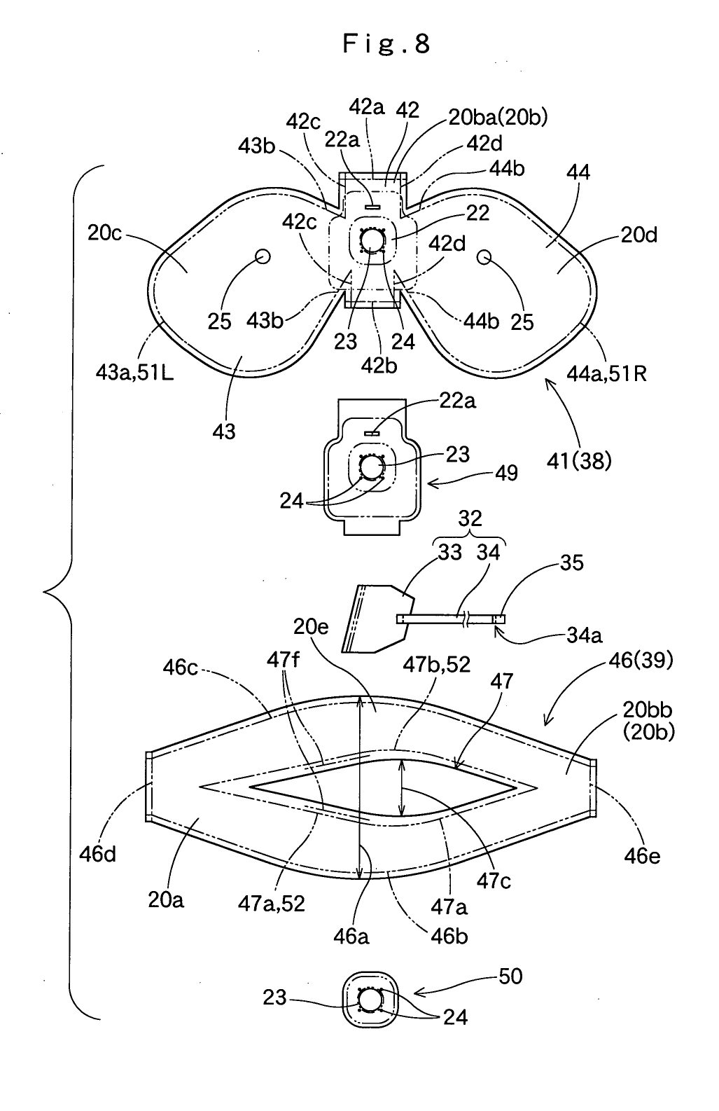

Airbag 20 is made by joining peripheral edges of predetermined shaped base cloths. As shown in FIG. 8, airbag 20 includes an outer panel 38 constituting left side wall 20c, right side wall 20d, and a front part 20ba of lower side wall 20b, and an inner panel 39 constituting upper side wall 20a, rear side wall 20e, and a rear part 20bb of lower side wall 20b. In this embodiment, airbag 20 is formed of a first base cloth 41 for constructing outer panel 38 and a second base cloth 46 for constructing inner panel 39.

First base cloth 41 has a laterally symmetric contour proximate to a figure of a butterfly spreading its wings. As shown in FIG. 8, first base cloth 41 includes a generally rectangular lower part 42 constituting the periphery 22 of gas inlet port 23 in vehicle body side portion 21, and left and right portions 43 and 44, each of which having a generally square plate shape, arranged in such a manner as to extend leftward and rightward from lower part 42. Lower part 42 makes front part 20ba of lower sidewall 20b of airbag 20 at complete inflation, which is the vicinity of gas inlet port 23. Left and right portions 43 and 44 mainly constitute left and right side walls 20c and 20d of airbag 20 at complete inflation.

Referring to FIG. 8, second base cloth 46 has a generally band shape in which upper side wall 20a, rear side wall 20e and a region to make rear part 20bb of lower side wall 20b are arranged in series. The opposite edges 46b and 46c of second base cloth 46 in the width direction, i.e. in the lateral direction as the airbag apparatus is mounted on vehicle, are so curved that the central portion of cloth 46 in the length direction i.e. in the longitudinal direction as the airbag apparatus is mounted on vehicle, has an increased width. In the illustrated embodiment, second base cloth 46 has a generally flat rhombic shape where a region to become upper side wall 20a has a wider width than a region to become lower side wall 20b. In the vicinity of the center of second base cloth 46 is a cut-out portion 47 extending along the length direction of cloth 46. Cut-out portion 47 is opened in a flat rhombic shape proximate to an outer contour of second base cloth 46. In other words, cut-out portion 47 is symmetric about its center line in the width direction, and is defined by opposite edges 47a and 47b that curvedly project toward the outer edges of cloth 46 at their center and are converged at opposite ends. As shown in FIG. 8, a widest portion 47c of cut-out portion 47 that has a widest opening width is located slightly toward a lower edge 46e, i.e. downward as the apparatus is mounted on vehicle, with respect to a widest portion 46a of second base cloth 46 that has a greatest width.

Left shoulder restraining portion 28L, right shoulder restraining portion 28R and recess 29 in protection portion 27 are formed by overlapping and sewing up peripheral edges of left and right portions 43 and 44 of first base cloth 41 and second base cloth 46, and peripheral edges 47a and 47b of cut-out portion 47 of second base cloth 46. A sewn portion or marginal joint portion 51L formed by sewing up an edge 43a of left portion 43 in first base cloth 41 and a left edge 46b of second base cloth 46, and a sewn portion or marginal joint portion 51R formed by sewing up an edge 44a of right portion 44 in first base cloth 41 and a right edge 46c of second base cloth 46 provide, respectively, projected tops 28a of shoulder restraining portions 28L and 28R, as shown in FIG. 7A. A sewn portion or central joint portion 52 formed by sewing up peripheral edges 47a and 47b of cut-out portion 47 of second base cloth 46 provides leading end 29a of recess 29 located between left and right shoulder restraining portions 28L and 28R. In the illustrated embodiment, attachment portion 33 of vertical tether 32 is coupled to a position 47f in the sewn portion 52 forward of widest portion 47c of cut-out portion 47 as shown in FIG. 8. Position 47f is disposed forward and upward of widest portion 47c when the apparatus is mounted on vehicle.

Airbag 20 is further provided with two reinforcing cloths 49 and 50 for reinforcing the periphery 22 of gas inlet port 23. Reinforcing cloth 49 is adapted to cover a generally entire area of inner surface of lower part 42 of first base cloth 41. Reinforcing cloth 50 has a generally square shape for reinforcing the periphery 22 of gas inlet port 23.

In this embodiment, first base cloth 41, second base cloth 46, reinforcing cloth 49, reinforcing cloth 50, and attachment portion 33 of vertical tether 32 are made of flexible woven fabric of polyester, polyamide or the like, not coated by coating agent such as silicone.

Manufacturing of airbag 20 is now described. Beforehand, vertical tether 32 is prepared by sewing up the leading end 34a of belt 34 into loop 35, and sewing root region 34b of belt 34 to attachment portion 33. Firstly, reinforcing cloth 49 and reinforcing cloth 50 are laid over the developed first base cloth 41 in order, and are respectively sewn to cloth 41 at inner and outer positions of mounting holes 24 in the periphery 22 of gas inlet port 23 by sewing yarn as shown in FIGS. 5 and 7. Reinforcing cloth 49 is further sewn to cloth 41 at the vicinity of its outer edge. Subsequently, punching work is applied to form through holes 22a, gas inlet port 23 and mounting holes 24. Alternatively, each of first base cloth 41, reinforcing cloths 49 and 50 may be provided with through holes 22a, gas inlet port 23 and mounting holes 24 in advance.

Thereafter, second base cloth 46 is folded back at the center in the width direction such that peripheral edges 47a and 47b of cut-out portion 47 overlap with each other. Attachment portion 33 of vertical tether 32 is placed in second base cloth 46 such that attachment portion 33 projects from position 47f, which position is located forward of widest portion 47c of cut-out portion 47, between peripheral edges 47a and 47b, and in this state, edges 47a and 47b are sewn up together with attachment portion 33, thereby providing sewn portion 52. Subsequently, second base cloth 46 is opened so that seam allowances of sewn portion 52 disposed inside, and an upper edge 46d of second base cloth 46 is sewn to a front edge 42a of lower part 42 of first base cloth 41. Likewise, lower edge 46e of second base cloth 46 is sewn to rear edge 42b of lower part 42 in first base cloth 41. Then front and rear left edges 42c of lower part 42 are sewn to root portions 43b of edge 43a in left portion 43, while right edges 42d are sewn to root portions 44b of edge 44a in right portion 44. Thereafter, edge 43a of left portion 43 and left edge 46b of second base cloth 46 are sewn up to provide sewn portion 51L, while edge 44a of right portion 44 and right edge 46c of second base cloth 46 are sewn up to provide sewn portion 51R. Subsequently, airbag 20 is reversed inside out utilizing gas inlet port 23 so that seam allowances may not appear outside. If then loop 35 formed at the leading end 34a of belt 34 of vertical tether 32 is taken out from through hole 22a, airbag 20 is complete.

To mount airbag 20 thus manufactured on vehicle, retainer 17 is placed inside airbag 20 so that bolts 17a are projected from mounting holes 24. Airbag 20 is then folded up with loop 35 protruded from through hole 22a, and a breakable wrapping sheet is wound around the folded-up airbag 20 to keep the folded-up configuration. At this time, loop 35 and bolts 17a are kept outside the wrapping sheet. Then the folded-up airbag 20 is placed on bottom wall 7 of case 6 so that bolts 17 are projected from bottom wall 7 and loop 35 projected out of through hole 7b. Thereafter, anchor pin 10 of anchor mechanism 9 secured to the lower side of bottom wall 7 of case 6 is put through loop 35 projected from bottom wall 7 to hold it. Subsequently, body 13a of inflator 13 is set in case 6 from lower side of bottom wall 7 while bolts 17a protruded downward from the bottom wall 7 are inserted through flange 13c of inflator 13. Thereafter, by fastening bolts 17a protruded from flange 13c of inflator 13 into nuts 18, the folded-up airbag 20 and inflator 13 are attached to bottom wall 7 of case 6.

Then if circumferential wall 8 of case 6 is attached to joint wall 15c of airbag cover 15 in dashboard 1 having been mounted on vehicle, and the unillustrated brackets of case 6 are fixed to predetermined positions of vehicle body, airbag device M1 for a front passenger's seat is mounted on vehicle.

After mounting airbag device M1 on vehicle, in the event of collision of vehicle, control device 57 feeds actuating signals to inflator 13 so that inflation gas G is discharged from gas discharge ports 13b of inflator 13 to inflate airbag 20. Airbag 20 breaks the wrapping sheet, and pushes and opens doors 15a and 15b of airbag cover 15 as shown in FIGS. 1, 10A and 10B. Then airbag 20 protrudes upward from an opening provided by the opening of doors 15a and 15b, and deploys rearward in such a manner as to fill in a space between top face 2 of dashboard 1 and windshield 4. Thus airbag 20 completes inflation as shown in FIGS. 1, 9A, 9B, 10A, 10B, 11 and 12.

Airbag apparatus M1 for a front passenger's seat embodying the present invention includes vertical tether or regulating member 32 that is capable of varying the lateral distance between left and right shoulder restraining portions 28L and 28R expected to contact with left and right shoulders SL and SR of passenger MP at complete airbag inflation.

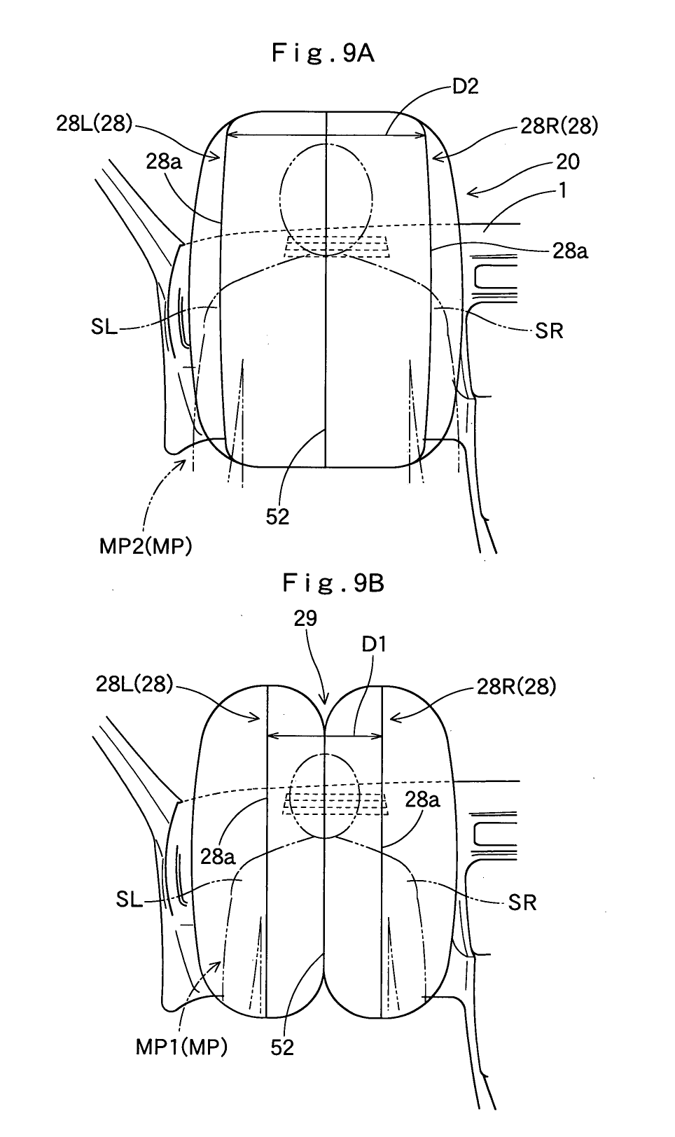

More specifically, if control device 57 detects a narrow-shouldered, undersized passenger MP1 seated in the front passenger's seat by signals fed from predetermined sensors 58, 59 and 60, the actuator 11 of anchor mechanism 9 is not actuated, so that airbag 20 deploys in the anchored state where loop 35 of vertical tether 32 is anchored by anchor pin 10. Then as shown in FIGS. 10B and 12, vertical tether 32 pulls a part of recess 29 between left and right shoulder restraining portions 28L and 28R so that recess 29 is significantly recessed whereas restraining portions 28L and 28R are projected, thereby rendering the lateral distance between restraining portions 28L and 28R the narrow distance D1 when airbag 20 completes inflation (FIGS. 9B, 10B, and 12).

On the contrary, if control device 57 detects a broad-shouldered, large passenger MP2 seated in the front passenger's seat, the actuator 11 actuates anchor mechanism 9 to retract anchor pin 10, so that airbag 20 deploys in the released state where loop 35 is released from anchor pin 10, as shown in FIGS. 9A and 11. Accordingly, vertical tether 32 does not pull the part of recess 29, and the lateral distance between restraining portions 28L and 28R becomes the wide distance D2 when airbag 20 is fully inflated (FIGS. 9A, 10A and 11).

To summarize, in the airbag apparatus M1, if an undersized passenger MP1 is seated in the front passenger's seat, the lateral distance between left and right shoulder restraining portions 28L and 28R upon airbag inflation is set for the narrow distance D1 correspondent to shoulders of undersized passenger MP1. On the contrary, if a large passenger MP2 is seated, the lateral distance upon airbag inflation is set for the wide distance D2 correspondent to shoulders of large passenger MP2. Consequently, if the size of passenger MP can vary, airbag 20 securely restrains left and right shoulders SL and SR of the passenger MP by shoulder restraining portions 28 (28L and 28R), thereby protecting passenger MP properly.

Therefore, airbag apparatus M1 for a front passenger's seat properly protects a passenger MP depending on the physical size of passenger MP.

In the airbag apparatus M1, when airbag 20 inflates with loop 35 released from anchor pin 10, airbag 20 is inflated into a contour more projected rearward in comparison with the instance where loop 35 is anchored by anchor pin 10 (FIGS. 10A and 11). On the contrary, when airbag 20 inflates with loop 35 anchored by pin 10, it is inflated into such a contour that vehicle body side portion 21 disposed forward of protection portion 27 has a greater lateral width in comparison with the instance where loop 35 is released from anchor pin 10 (FIGS. 10B and 12).

Airbag apparatus M1 includes vertical tether 32 as the regulating member whose first end is coupled to a part of recess 29 between left and right shoulder restraining portions 28L and 28R of protection portion 27. When airbag 20 inflates with loop 35 anchored by anchor pin 10, tether 32 is pulled by pin 10, so that a space between restraining portions 28L and 28R is recessed whereas restraining portions 28L and 28R are projected and the lateral distance between restraining portions 28L and 28R is set for narrow distance D1 at the complete airbag inflation. In other words, when an undersized passenger MP1 is seated, airbag 20 completes inflation in a state where restraining portions 28L and 28R are significantly projected whereas recess 29 is significantly recessed as shown in FIG. 12. With this arrangement, when the inflated air bag 20 is thrown against undersized passenger MP1, left and right shoulder restraining portions 28L and 28R firstly bump against the vicinities of left and right shoulders SL and SR of passenger MP1, thereby reducing forward kinetic energy of passenger MP1. Thereafter, ahead MH of under sized passenger MP1 whose shoulders SL and SR are restrained by restraining portions 28L and 28R enters into recess 29 provided between restraining portions 28L and 28R as shown in FIGS. 10B and 12, and then is restrained and suppressed from moving forward. Accordingly, airbag 20 is capable of receiving head MH of undersized passenger MP1 while applying less reaction force.

In the airbag apparatus M1, second base cloth 46 forming inner panel 39 of airbag 20 has a generally band shape wherein upper side wall 20a, rear side wall 20e and a region to make rear part 20bb of lower side wall 20b are arranged in series. The edge regions of inner panel 39 in the width direction, i.e. left edge 46b and right edge 46c of second base cloth 46 are sewn up with the edge 43a of left portion 43 and the edge 44a of right portion 44 in first base cloth 41 or outer panel 38, respectively, so as to provide projected tops 28a of left and right shoulder restraining portions 28L and 28R. Moreover, inner panel 39 includes sewn portion or central joint portion 52 formed by overlapping and sewing up peripheral edges 47a and 47b of cut-out portion 47 of second base cloth 46 in the central region of the width direction of inner panel 39, and vertical tether 32 is connected to this sewn portion 52. In addition, when second base cloth 46 is developed in a flattened manner before the peripheral edges 47a and 47b of cut-out portion 47 are sewn up to form the central joint portion 52, the peripheral edges 47a and 47b are curved in such a manner as to project toward opposite ends in their width direction at the vicinity of their longitudinal center. With this structure, if airbag 20 inflates with vertical tether 32 released from anchor mechanism 9, sewn portion 52 is arranged in a slightly recessed manner (FIGS. 7A and 11) and defines leading end 29a of recess 29 extending in the longitudinal direction between left and right shoulder restraining portions 28L and 28R.

In view of this and since vertical tether 32 is connected to this sewn portion 52 extending continuously from upper side to rear side of airbag 20, if tether 32 is pulled, the whole inner panel 39 is smoothly drawn in toward gas inlet port 23 headed by sewn portion 52, so that projected tops 28a of shoulder restraining portions 28L and 28R formed on left edge 46b and right edge 46c of second base cloth 46 or inner panel 39 move to reduce the distance therebetween. Accordingly, the lateral distance between left and right shoulder restraining portions 28L and 28R is smoothly reduced merely by pulling sewn portion 52 by vertical tether 32, which is preferable.

Sewn portions or marginal joint portions 51L and 51R defining projected tops 28a of left and right shoulder restraining portions 28L and 28R are formed by sewing up the edge (outer edge) 43a of left portion 43 and the edge (outer edge) 44a of right portion 44 of first base cloth 41 or outer panel 38 respectively with left edge 46b and right edge 46c of second base cloth 46 or inner panel 39. These edges 43a, 44a, left edge 46b and right edge 46c are curved in such a manner as to protrude outward in outer panel 38 and inner panel 39, and therefore, define the largest circumference of airbag 20 in the longitudinal direction. In view of this, if sewn portion 52 is pulled by vertical tether 32 to draw in the whole inner panel 39 toward gas inlet port 23 upon airbag deployment, the edge portions easily form the most projected portions. Therefore, when the lateral distance between left and right shoulder restraining portions 28L and 28R is set for narrow distance D1 upon airbag inflation, left and right shoulder restraining portions 28L and 28R securely restrain left and right shoulders SL and SR of undersized passenger MP1 with their most projected portions 28a.

Furthermore, opposite edges of second base cloth 46 constituting inner panel 39 in the width direction are curved to curvature of left and right portions 43 and 44 of first base cloth 41 constituting outer panel 38 so that the central region of second base cloth 46 in the longitudinal direction has a greater width. With this structure, projected tops 28a of shoulder restraining portions 28L and 28R extend generally in the vertical direction at the complete inflation of airbag 20. Accordingly, if the position of passenger MP varies vertically, left and right shoulder restraining portions 28L and 28R smoothly restrain shoulders SL and SR of passenger MP.

In airbag 20 according to this specific embodiment, sewn portion or central joint portion 52 is formed by overlapping and sewing up peripheral edges 47a and 47b of cut-out portion 47. However, the central joint portion may be formed by overlapping and connecting predetermined regions of an inner panel having no cut-out portion. Moreover, although inner panel 39 is constructed of a single piece of second base cloth 46 provided with cut-out portion 47, the contour of the inner panel should not be limited thereby. For example, the inner panel may be fabricated of a pair of base cloths which have such symmetric contours as the inner panel is split up into two at a position defining the central joint portion, i.e. two pieces of base cloths which are symmetric about the center line in the width direction. Furthermore, in order for vertical tether 32 to draw in the whole inner panel 39 toward gas inlet port 32 smoothly, it is desirable that the inner panel 39 is provided with sewn portion or central joint portion 52 to head the drawing move and that vertical tether 32 is joined to this central joint portion 52. If such an advantage is not considered, however, the inner panel may be formed of a single piece of base cloth having no central joint portion.

Although outer panel 38 of airbag 20 is formed by a single piece of first base cloth 41 having a contour proximate to a figure of a butterfly spreading its wings, the contour of the outer panel should not be limited thereby. The outer panel may be constructed of a pair of two base cloths split up into a left portion and a right portion. In addition, although airbag 20 is manufactured by sewing up the edges of base cloths 41 and 46 using sewing thread, means for connecting the edges of the base cloths should not be limited thereby, but adhesive or the like may be used to connect the edges of the base cloths.

Moreover, in the airbag apparatus M1, vertical tether 32 includes the attachment portion 33 disposed at the rear end side and the belt 34 disposed at the front side. Attachment portion 33 disposed at the rear end side has a generally trapezoidal band shape, and is joined to central joint portion or sewn portion 52 in a state where the rear end of attachment portion 33 is arranged along sewn portion 52. This structure is advantageous since the joint strength of vertical tether 32 or attachment portion 33 to sewn portion 52 is stabilized. In addition, in the airbag apparatus M1, the joint 33a of vertical tether 32 to sewn portion 52 constitutes the most recessed region of the recess 29 formed between the shoulder restraining portions 28L and 28R when airbag 20 inflates with the narrow distance D1 corresponding to undersized passenger MP1 (FIG. 6B). Accordingly, since the joint 33a has a certain amount of width extending along sewn portion 52, the recessed shape of recess 29 will be stabilized, which is preferable.

Furthermore, in airbag apparatus M1, the joint 33a of vertical tether 32 to sewn portion 52 is located at a position to confront a head MH of undersized passenger MP1 (FIG. 6B) when airbag 20 completes inflation with vertical tether 32 pulled forward. This structure is advantageous because recess 29 will receive head MH of undersized passenger MP1 with the most recessed portion, that is, recess 29 will receive head MH in a soft manner.

Airbag apparatus M1 for a front passenger's seat employs anchor mechanism 9 as the mechanism to pull vertical tether 32 serving as the regulating member. Anchor mechanism 9 anchors the leading end 34a of belt 34 to pull vertical tether 32, and releases the leading end 34a so that the substantial length of vertical tether 32 be infinite. Thus airbag apparatus M1 adjusts the length of vertical tether 32 to change the lateral distance between left and right shoulder restraining portions 28L and 28R upon airbag inflation. In other words, airbag apparatus M1 according to the foregoing embodiment employs anchor mechanism 9 as a means for adjusting the length of vertical tether 32 as well as the pulling mechanism to pull tether 32 in the retaining mode. The means for adjusting the length of vertical tether 32 should not be limited to thereby, though. It will also be appreciated to employ a pulling mechanism including a wind roll used in a later-described airbag apparatus M2 for adjusting the length of vertical tether 32. In that instance the length of vertical tether 32 will be reduced when the wind roll is actuated. With such a wind roll, the length of vertical tether 32 will be adjustable in more than two stages, unlike the foregoing embodiment where the length is adjustable in two stages, so that the lateral distance between left and shoulder restraining portions 28L and 28R at the complete airbag inflation will be adjustable in more than two stages. Furthermore, a feed roll may be used as the means for adjusting the length of the vertical tether. In this instance, the vertical tether will be reduced in length when the feed roll is not actuated so the lateral distance between the left and shoulder restraining portions will be reduced, whereas the vertical tether will be lengthened when the feed roll is actuated to spin or unreel the tether so the lateral distance between left and shoulder restraining portions is broadened.

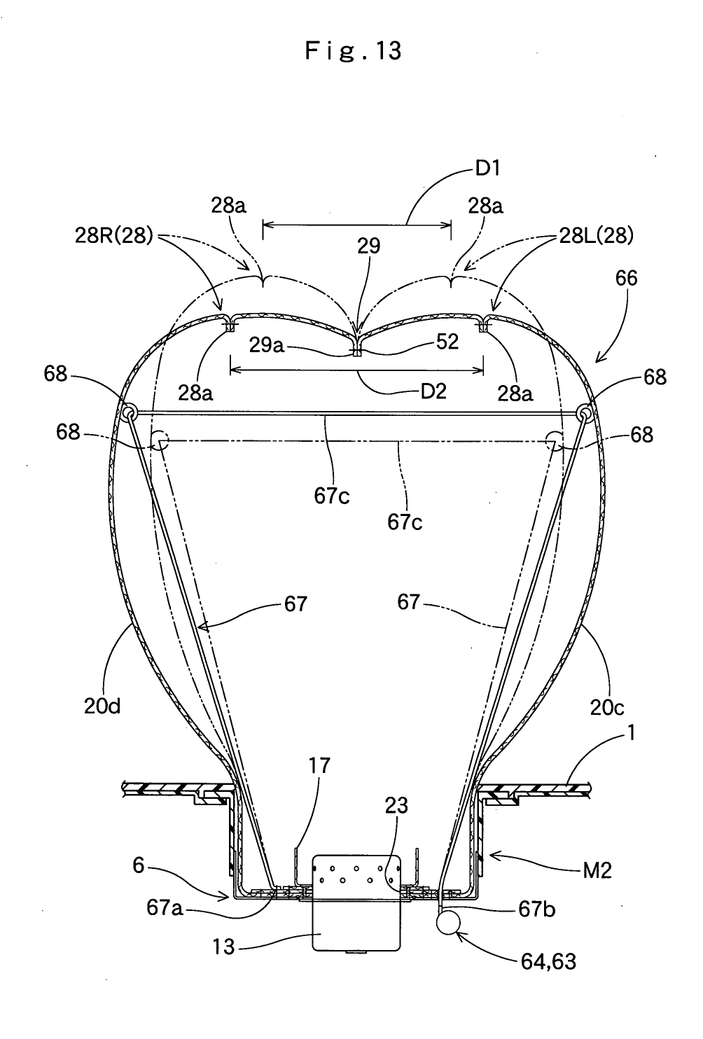

An alternative embodiment of the present invention is now described. An airbag apparatus M2 for a front passenger's seat shown in FIG. 13 has a similar structure to the afore described airbag apparatus M1 except an airbag 66 and a pulling mechanism 63 for pulling a tether 67 disposed inside airbag 66, and therefore, descriptions of common members will be omitted by using common reference numerals.

Pulling mechanism 63 is disposed proximate and to the left side of insert hole 7a on the lower side of bottom wall 7 of case 6. In this specific embodiment, pulling mechanism 63 is a wind roll 64 for rewinding the leading end 67b side of tether 67 put through bottom wall 7 of case 6 and connected to wind roll 64. Wind roll 64 is adapted to be actuated to rewind tether 67 when a control device detects a narrow-shouldered, undersized passenger MP1 being seated.

Airbag 66 has a similar construction to the above-described airbag 20 except tether 67 arranged as the regulating member, and therefore, descriptions of common members will be omitted by using common reference numerals. Tether 67 is made of a band-shaped material, and is arranged inside airbag 66 in such a manner as to form a ring or a generally trapezoidal shape as viewed from above or below, connecting the vicinity of gas inlet port 23, a generally vertically central position in the vicinity of the rear end of left side wall 20c, and a generally vertically central position in the vicinity of the rear end of right side wall 20d. A root portion 67a of tether 67 is coupled to a region of airbag 66 proximate to and to the right side of gas inlet port 23. An intermediate region of tether 67 is movably joined to left side wall 20c and right side wall 20d, and leading end 67b is put out from the left side periphery of gas inlet port 23 and connected to wind roll 64 or pulling mechanism 63. Tether 67 is put through ring members 68 disposed on the inner surface of left side wall 20c and right side wall 20d so it is movable with respect to walls 20c and 20d. Since tether 67 is movably connected to walls 20c and 20d while being anchored at root portion 67a to the vicinity of gas inlet port 23, if pulling mechanism 63 or wind roll 64 is actuated to rewind tether 67, the trapezoidal shape of tether 67 before being rewound is contracted as a whole as indicated by phantom lines in FIG. 13. Accordingly, ring members 68 which tether 67 runs through approach each other, thereby reducing the length of a region of tether 67 between ring members 68 or a laterally tethered portion 67c. As a result, the distance between left side wall 20c and right side wall 20d in the lateral direction is reduced, whereas sewn portion 52 defining leading end 29a of recess 29 is held from being deformed by being pulled in a sectional view taken along the longitudinal direction. Since sewn portion 52 is not deformed significantly, regions around sewn portion 52 come to be deformed. As indicated by the phantom lines in FIG. 13, consequently, projected tops 28a of left and right shoulder restraining portions 28L and 28R move toward sewn portion 52 while projecting rearward, so that airbag 66 completes inflation in a state where the lateral distance between shoulder restraining portions 28L and 28R is reduced.

The length of tether 67 is predetermined such that, when airbag 66 completes inflation with tether 67 unrewound by wind roll 64, the distance between left and right shoulder restraining portions 28L and 28R in the lateral direction becomes wide distance D2 suited to a large passenger whereas the distance becomes narrow distance D1 suited to a undersized passenger when airbag 66 completes inflation with tether 67 rewound by wind roll 64.

In airbag apparatus M2, too, when the control device detects a narrow-shouldered, undersized passenger seated in the front passenger's seat, pulling mechanism 63 or wind roll 64 is actuated to rewind tether 67 such that airbag 66 completes inflation in a state where the distance between left side wall 20c and right side wall 20d is reduced in the lateral direction as well as the distance between left and right shoulder restraining portions 28L and 28R in the lateral direction is reduced to narrow distance D1. On the contrary, when the control device detects a broad-shouldered, large passenger seated in the seat, pulling mechanism 63 or wind roll 64 is not actuated, so that airbag 66 completes inflation in a state where the distance between left and right side walls 20c and 20d is broadened in the lateral direction as well as the distance between shoulder restraining portions 28L and 28R in the lateral direction is broadened to wide distance D2.

To summarize, when a undersized passenger is seated in the front passenger's seat, the lateral distance between left and right shoulder restraining portions 28L and 28R is set for narrow distance D1 correspondent to shoulders of the undersized passenger upon airbag inflation, whereas the distance is set for wide distance D2 correspondent to shoulders of the large passenger when a large passenger is seated. Consequently, if the size of a seated passenger can vary, the fully inflated airbag 66 securely restrains shoulders of the passenger by shoulder restraining portions 28 (28L and 28R), thereby protecting the passenger properly.

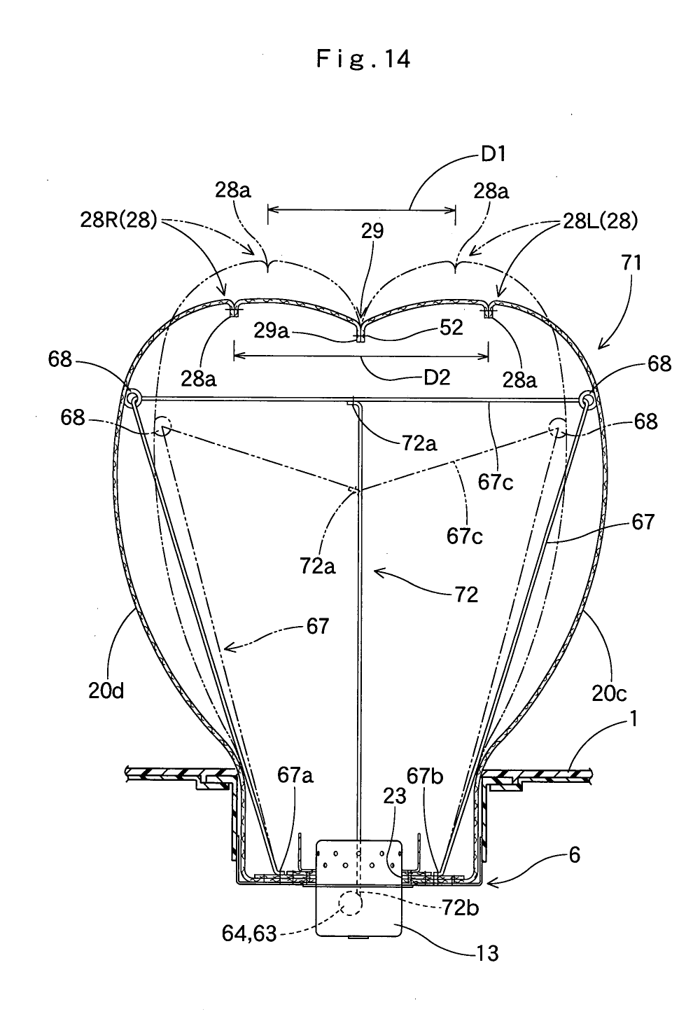

An airbag for the foregoing embodiment may be constructed like an airbag 71 shown in FIG. 14. Airbag 71 includes a tether 67 arranged inside airbag 71 in a ring shape, wherein a root portion 67a and leading end 67b of tether 67 are connected to the periphery of gas inlet port 23. Tether 67 includes a laterally tethered portion 67c and a pulling portion 72 arranged to extend along the longitudinal direction. The root portion 72a of pulling portion 72 is joined to a central region of laterally tethered portion 67c whereas the leading end 72b of pulling portion 72 projects through the periphery of gas inlet port 23 for connection to pulling mechanism 63 or wind roll 64 constructed in a similar manner to that of above-described airbag apparatus M2. As indicated by phantom lines in FIG. 14, if pulling portion 72 is rewound in airbag 71, the central region of laterally tethered portion 67c moves toward gas inlet port 23 so that the distance between left and right side walls 20c and 20d is reduced in the lateral direction. The length of pulling portion 72 is predetermined such that, when airbag 71 completes inflation with pulling portion 72 unrewound by wind roll 64, the distance between left and right shoulder restraining portions 28L and 28R in the lateral direction becomes wide distance D2 suited to a large passenger whereas the distance becomes narrow distance D1 suited to an undersized passenger when airbag 71 completes inflation with pulling portion 72 rewound by wind roll 64.

In the foregoing embodiments, the laterally tethered portions of airbags 66 and 71 which connect left side wall 20c and right side wall 20d are described as part of tethers 67 arranged inside the airbags in a ring shape. However, the laterally tethered portion may be arranged along the lateral direction to connect the left side wall and right side wall independently.

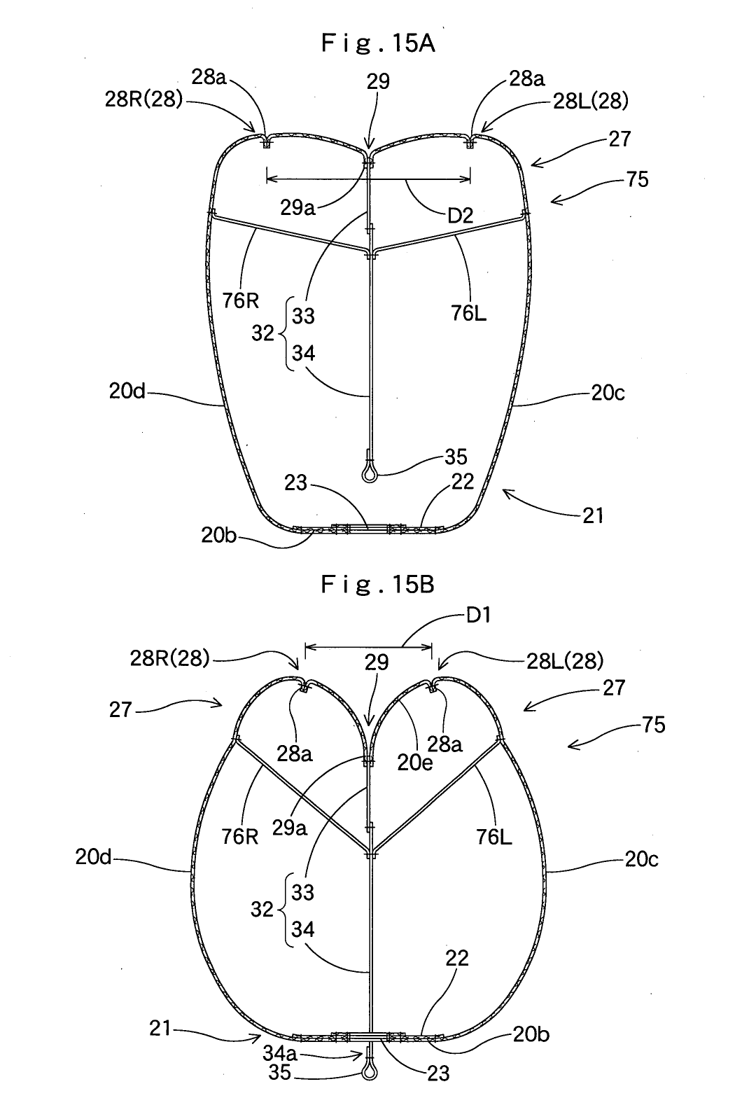

Alternatively, airbag may be constructed like an airbag 75 shown in FIGS. 15A and 15B. Airbag 75 internally includes laterally tethered portions 76L and 76R interconnecting a belt 34 of a vertical tether 32, a left side wall 20c and a right side wall 20d. Except laterally tethered portions 76L and 76R, airbag 75 is constructed similarly to the above-described airbag 20. In airbag 75, when airbag 75 inflates with vertical tether 32 anchored by anchor mechanism 9, laterally tethered portions 76L and 76R pull left side wall 20c and right side wall 20d toward gas inlet port 23, too. In other words, if vertical tether 32 is retained by anchor mechanism 9, the distance between left and right side walls 20c and 20d in the lateral direction in protection portion 27 is reduced upon airbag inflation in comparison with an instance where airbag 75 inflates with vertical tether 32 released from anchor mechanism 9. In this instance, vehicle body side portion 21 increases its lateral width as shown in FIG. 15B as a result of protection portion 27 configured to have the reduced lateral width.

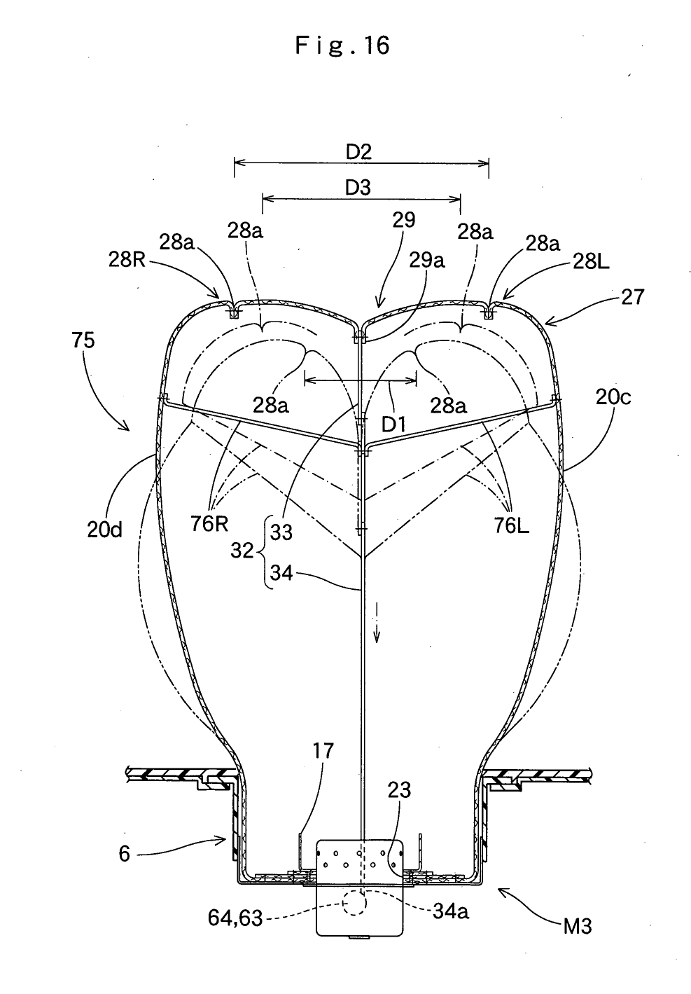

FIG. 16 shows further alternative embodiment of the present invention. An airbag apparatus M3 shown in FIG. 16 includes an airbag 75 wherein a leading end 34a of belt 34 of vertical tether 32 is connected to a wind roll 64 or pulling mechanism 63 to adjust the length of belt 34 or vertical tether 32. In this airbag apparatus M3, vertical tether 32 is adjustable in length in more than two stages. For instance, upon airbag inflation, the lateral distance between left and right shoulder restraining portions 28L and 28R can be set for an intermediate distance D3 between narrow distance D1 and wide distance D2 as indicated by projected lines in FIG. 16.

What is claimed is:

1. An airbag apparatus for a front passenger's seat comprising:
an airbag folded and housed inside an instrument panel in front of the front passenger's seat, and being deployable rearward when fed with inflation gas, the airbag, when completely inflated, being formed into a contour having a left side wall and a right side wall deployed at lateral sides of the airbag, an upper side wall and a lower side wall deployed in upper and lower sides of the airbag, and a rear sidewall arranged generally vertically to face toward the front passenger's seat, the airbag further comprising a gas inlet port for introducing inflation gas and a protection portion contactable with a passenger seated in the front passenger's seat, in a rear side of the airbag as completely inflated; and
a regulating member for controlling the contour of the airbag at complete inflation depending upon the passenger,
the protection portion comprises each one left and right shoulder restraining portion disposed side by side along the lateral direction and contactable with left and right shoulders of the passenger upon airbag inflation, and
the regulating member varies a distance between the shoulder restraining portions in the lateral direction at the complete inflation of airbag depending upon the passenger, to a wide distance correspondent to a large passenger and to a narrow distance correspondent to an undersized passenger.

2. The airbag apparatus for a front passenger's seat according to claim 1, wherein:
the regulating member comprising a vertical tether arranged along the longitudinal direction, one of opposite ends of the vertical tether being connected to a region of the protection portion between the left and right shoulder restraining portions, such that, when the vertical tether is pulled forward to make a space between the shoulder restraining portions recessed whereas the shoulder restraining portions projected, the distance between the shoulder restraining portions in the lateral direction becomes the narrow distance.

3. The airbag apparatus for a front passenger's seat according to claim 2, wherein:
the airbag is formed by joining edges of predetermined-shaped base cloths;
the airbag comprises:
an outer panel constituting the left side wall and the right side wall; and
an inner panel constituting the upper sidewall, the lower side wall and the rear side wall;
the inner panel has a generally band shape wherein the upper side wall, the rear side wall and the lower side wall are arranged in series, opposite edges in a width direction of the inner panel are curved such,that a central region in a length direction of the inner panel has a wider width;
the inner panel includes a central joint portion extending along the length direction in the vicinity of a center in the width direction of the inner panel, the central joint portion being formed by overlapping and joining a part of the inner panel;
opposite edges of the central joint portion before being joined are curved to project toward opposite sides in a width direction of the central joint portion at a central region in a length direction of the central joint portion when the inner panel is flattened and developed;
marginal joint portions, which is formed by joining outer edges of regions of the outer panel to form the left and right side walls and opposite edges of the inner panel in the width direction, constitute projected tops of the left and right shoulder restraining portions of the protection portion;
the central joint portion constitutes a recess arranged continuously from an upper side to rear side of the airbag between the left and right shoulder restraining portions; and
the vertical tether is connected to the central joint portion of the inner panel at the one of opposite ends of the vertical tether.

4. The airbag apparatus for a front passenger's seat according to claim 3, wherein:
at least a rear end region of the vertical tether has a band shape extending generally vertically; and
the vertical tether is joined to the central joint portion in a state where a rear end of the rear end region is arranged along the central joint portion.

5. The airbag apparatus for a front passenger's seat according to claim 4, wherein:
a joint of the vertical tether to the central joint portion is located at a position to confront a head of the undersized passenger when the airbag completes inflation with the vertical tether pulled forward.

6. The airbag apparatus for a front passenger's seat according to claim 1, wherein:
the regulating member comprises a laterally tethered portion arranged along the lateral direction to connect the left side wall and right side wall, and
the distance between the shoulder restraining portions in the lateral direction at the complete inflation of airbag is set for the narrow distance when the laterally tethered portion is pulled.
